(19) United States
(12) Patent Application Publication
(10) Pub. No.: US 2005/0236866 A1
(43) Pub. Date: Oct. 27, 2005

(54) Sliding door and vehicle with a sliding door

(76) Inventor: Jean-Marc Belmond, St. Jean Le Blanc (FR)

Correspondence Address: CARLSON, GASKEY & OLDS, P.C., 400 WEST MAPLE ROAD, SUITE 350, BIRMINGHAM, MI, 48009, US

(21) Appl. No.: 11/111,462

(22) Filed: Apr. 21, 2005

(30) Foreign Application Priority Data
Apr. 23, 2004 (FR) 04 04 331

(51) Int. Cl. B60J 5/06

(52) U.S. Cl. 296/155

(57) ABSTRACT

A vehicle includes a sliding door, and an electrical lock for the sliding door is on the vehicle bodywork and not on the door. This allows power to be provided to the lock while the sliding door is in an open position and the lock to be electrically returned to an original position after it has been actuated.

### REFERENCE TO RELATED APPLICATION

This application claims priority to French Patent Application FR 04 04 331 filed on Apr. 23, 2004.

### BACKGROUND OF THE INVENTION

The present invention relates generally to a sliding door and a vehicle including a sliding door.

Electrical systems for closing sliding doors are divided into two sub-assemblies including a mechanical lock fixed on a rear edge of the sliding door and a door controller for a mechanical door closure fixed on an inner panel of the door. Numerous mechanical connections are required to connect the lock to the door controller and to connect the door controller to a hook to maintain the door in an open.

Moreover, to close the door, the lack of potential energy combined with the rigidity of seals between the door and the vehicle bodywork require (both for sliding doors and for swing doors) substantial force to close the door. For this reason, motor vehicle manufacturers and motor vehicle equipment manufacturers develop locks which assist door closure electrically.

One problem with sliding doors is providing power to the door equipment (such as the power supply of the electrical opening lock) because a cable cannot permanently pass near the hinges, as is the case in a swing door. This problem particularly arises when the sliding doors are open. The electrical opening lock on the door is not supplied with power and cannot electrically return to an initial position after it is actuated to open the door. Sliding doors must thus be equipped with additional components to return the lock to the initial position, such as springs of the appropriate size. This has repercussions on the complexity of the mechanisms for closing the sliding doors and on the cost of the doors.

A need therefore exists for sliding doors which are less expensive and have simpler closing mechanisms.

### SUMMARY OF THE INVENTION

The present invention provides a vehicle sliding door including a hook to retain the door in an open position and a finger that cooperates with an electrical lock of the vehicle to retain the door in a closed position. The door includes at least one opening control that has a mechanical connection to the hook to mechanically actuate the hook and a set of sensors to trigger the electrical opening of the lock.

According to one embodiment, the door includes an outside opening control and an inside opening control. Each control has a set of sensors to trigger the electrical opening of the lock. According to one embodiment, a cable connects the opening controls to the hook.

The invention also relates to a vehicle including a bodywork, a sliding door and an electrical lock on the bodywork. According to one embodiment, the bodywork of the vehicle includes an actuator for closing the door and moving the lock from a safety position to a fully closed position.

According to one embodiment, the sliding door includes a finger that cooperates with the electrical lock to retain the door in the closed position. According to one embodiment, the sliding door includes at least one opening control and a set of sensors. The electrical lock is opened by signals from the sensors that are triggered by actuating the opening control.

According to one embodiment, the vehicle has an emergency opening control. According to one embodiment, the vehicle has a lock pillar, and the lock is in the lock pillar of the vehicle. According to one embodiment, the sliding door of the vehicle includes the features as described above.

Other characteristics and advantages of the invention will become apparent when reading the following detailed description of embodiments of the invention, given by way of example only and with reference to the single figure.

### BRIEF DESCRIPTION OF THE DRAWING

Other features and advantages of the invention will become apparent on reading the following detailed description of embodiments of the invention, given by way of example only and with reference to the appended sole drawing in which:

FIG. 1 is a schematic representation of a vehicle sliding door according to one embodiment of the invention.

### DETAILED DESCRIPTION OF PREFERRED EMBODIMENTS

The invention provides a sliding door and a vehicle, and an electrical door opening lock is on the bodywork of the vehicle and not on the door. This allows power to be supplied to the lock in a simple way while the sliding door is in an open position and the lock to be electrically returned to an initial position after the lock has been actuated.

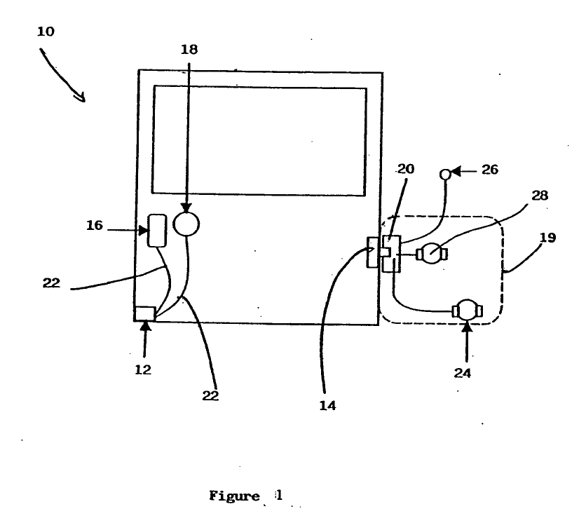

FIG. 1 shows one example of a schematic representation of a vehicle sliding door 10. The vehicle has a bodywork 19, of which only the component is shown. The vehicle also includes an electrical opening lock 20 on the bodywork 19. The sliding door 10 has a hook 12 that retains the sliding door 10 in the open position. The door 10 also includes a finger 14 that cooperates with the opening lock 20. In FIG. 1, an opening controls 16 and 18 are also shown in the sliding door 10.

The door 10 is of the sliding type, and access to the vehicle is allowed or prevented by a lateral displacement of the door 10 along the vehicle in a direction of movement of the vehicle. The actual opening and closing movements of the door 10 are carried out by a shift of the door 10 in a direction transverse to the direction of movement of the vehicle. The door 10 is not articulated around hinges, and it is complex or even impossible for safety reasons to provide power to the equipment of the door 10 via a cable that passes from the bodywork 19 to the door 10.

The lock 20 is an electrically-opening lock. A vehicle battery powers operation of an actuator 28 of the lock 20 to electrically ensure the lock 20 opens. The lock 20 allows the door 10 to be retained in a closed position. The lock 20 in FIG. 1 is mounted on the bodywork 19 of the vehicle. The lock 20 is, for example, mounted on a leg C or a lock pillar of the bodywork 19. The lock pillar extends along a rear edge of the door 10. The position of the lock 20 prevents problems in the powering of the lock 20, and in particular prevents problems in returning the lock 20 to the initial position once the door 10 is open. Because the lock 20 is positioned on the vehicle bodywork 19, it can be powered by the vehicle battery, regardless of the position of the door 10. In particular, the lock 20 can be electrically returned to the initial position because the lock 20 is still supplied with power after opening the door 10. Thus, because the lock 20 is not in the door 10, a complex system for returning the lock 20 to the initial position (of the type with a spring or of the independently-powered type) is not needed. Consequently, the lock 20 located on the bodywork 19 can be supplied with power in a simpler, safer and also less expensive way.

The finger 14 of the door 10 cooperates with the electrical opening lock 20 and allows the door 10 to be maintained in the closed position. The lock 20 has a claw that fixes the finger 14 of the door 10 relative to the lock 20 or releases the finger 14. Opening the lock 20 releases the finger 14, which releases the door 10 from the hook 12. Conversely, closing the lock 20 retains the finger 14 in the lock 20, preventing the door 10 from being released from the hook 12. The claw is forced towards a closed position by the finger 14 when the door 10 is closed. A pawl prevents the claw from returning to an open position, and the lock 20 is held in the closed position when the lock 20 is not operated externally.

An action on the opening controls 16 and 18 of the door 10 releases the door 10 from the hook 12 and allows the door 10 to be opened. The action on the opening controls 16 and 18 allows the finger 14 to be released from the electrical lock 20. For this purpose, a set of at least two sensors (not shown) triggers the electrical opening of the lock 20 when an action is carried out on the opening controls 16 and 18. Each sensor delivers a signal when the opening controls 16 and 18 is actuated, for example to a door controller situated in the passenger compartment. The door controller then relays the signals from the sensors to the electrical lock 20. When the signals are received from the sensors, the door controller can control the opening of the lock 20 or can stop the opening of the lock 20, in particular if the vehicle is moving. The sensors can be integrated in the opening controls 16 and 18, which facilitates their installation in the vehicle because the sensors will thus be installed at the same time as the opening controls 16 and 18. The sensors are, for example, a micro switch and a Hall-effect sensor, which are inexpensive. For reasons of reliability and security, several sensors with different technology are installed.

The sensors in the door 10 trigger the door 10 to open and must be operational when the door 10 is closed. The power supplied to the sensors is then established by connectors on the door 10 and on the bodywork 19 which again contact each other when the door 10 is closed. However, because the sensors do not have to be operational when the door 10 is closed, the problem of providing power to the sensors when the door 10 is open no longer occurs.

The door 10 shown in FIG. 1 includes two opening controls: an external opening control 16 and an internal opening control 18. The opening controls 16 and 18 are, for example, door-opening handles. Each of the opening controls 16 and 18 has several sensors, and operating one of the opening controls 16 and 18 from inside or outside the vehicle allows the door 10 to be released from the hook 12.

The hook 12 allows the door 10 to be retained in the open position. When the door 10 is open and then drawn towards the rear of the vehicle, the hook 12 immobilizes the door 10 at the end of travel by a known means. The hook 12 is on an assembly guiding the translation of the door 10. The hook 12 can, for example, be near the front leaf of the door 10.

The opening controls 16 and 18 have a mechanical connection to the hook 12 to mechanically actuate the hook 12 and close the door 10. This allows the hook 12 to be actuated without power. In particular, this allows the hook 12 to be actuated when the sliding door 10 is open and power is not provided. The mechanical connection is, for example, a cable 22. In FIG. 1, a cable 22 connects each of the exterior opening control 16 and interior opening control 18 with the hook 12, allowing the hook 12 to be mechanically actuated from inside and outside the vehicle.

The door 10 is thus provided with a simpler and less expensive closing system. Moreover, the lock 20 installed in the bodywork 19 can be of the same kind as the locks currently used for swing doors, reducing costs due to economies of scale.

Moreover, the vehicle can include an actuator 24 of the lock 20. The actuator 24 is outside the lock 20. The actuator 24 ensures electrical actuation of the lock 20 while assisting in the closing of the lock 20. The actuator 24 in the vehicle bodywork 19 ensures closure of the door 10 and movement of the lock 20 from a safety position to a fully closed position. In other words, when the finger 14 of the door 10 is caught in the lock 20 (a first position or the safety position), without being sufficiently driven into the lock 20 to immobilize the door 10, the actuator 24 then drives the claw of the lock 20. The door 10 is then driven in its closing movement towards a door immobilization position (a second position or the fully closed position). This avoids using a motorized door-closing device or using a very substantial force to compensate for the small amount of useable kinetic energy in the door 10. This also overcomes the rigidity of the seals. The actuator 24 is mounted on the vehicle bodywork 19, allowing it to be supplied with power regardless of the position of the sliding door 10.

It can also be envisioned that the vehicle has an emergency opening control 26. The control 26 opens the lock 20 when there is an interruption in the supply of power to the lock 20 from the vehicle battery, such as in the event of an accident. The emergency control can be in the trunk, which prevents it being actuated by a backseat passenger during normal operation of the vehicle. The emergency control can also be made accessible to the backseat passenger, which allows it to be actuated more easily by the backseat passenger in the event of an accident. During normal vehicle operation, to prevent a backseat passenger (such as a child) from actuating the emergency control which is accessible to him, the emergency control can remain deactivated. In the event of an accident, the emergency control is however restored, for example by providing a capacitor which discharges to compensate for the lack of power to the lock and to allow the lock to be opened.

Of course, the present invention is not limited to the embodiments described here by way of example, thus the invention is not limited to a sliding door but could be applied to a swing-door.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

1. A sliding vehicle door comprising:
a hook to retain the sliding vehicle door in an open position;
a finger to cooperate with an electrical lock of a vehicle and to retain the sliding vehicle door in a closed position;
at least one opening control having a mechanical connection to the hook to mechanically actuate the hook; and
sensors to trigger an electrical opening of the electrical lock.

2. The door according to claim 1, wherein the at least one opening control comprises an exterior opening control and an interior opening control each including the sensors to trigger the electrical opening of the electrical lock.

3. The door according to claim 2, further including a first cable that connects the exterior opening control to the hook and a second cable that connects the interior opening control to the hook.

4. The door according to claim 1, further including a cable that connects the at least one opening control to the hook.

5. A vehicle comprising:
a bodywork;
a sliding door; and
an electrical lock on the bodywork.

6. The vehicle according to claim 5, wherein the sliding door includes:
a hook to retain the sliding door in an open position,
a finger to cooperate with the electrical lock and to retain the sliding door in a closed position,
at least one opening control including a mechanical connection to the hook to mechanically actuate the hook; and
sensors to trigger an electrical opening of the electrical lock.

7. The vehicle according to claim 5, wherein the bodywork includes an actuator for closing the sliding door and for moving the electrical lock from a safety position to a fully closed position.

8. The vehicle according to claim 7, wherein the sliding door includes:
a hook to retain the sliding door in an open position,
a finger to cooperate with the electrical lock and to retain the sliding door in a closed position,
at least one opening control including a mechanical connection to the hook to mechanically actuate the hook; and
sensors to trigger an electrical opening of the electrical lock.

9. The vehicle according to claim 5, wherein the sliding door includes a finger that cooperates with the electrical lock to retain the sliding door in a closed position.

10. The vehicle according to claim 9, wherein the sliding door includes:
a hook to retain the sliding door in an open position,
at least one opening control including a mechanical connection to the hook to mechanically actuate the hook, and
sensors to trigger an electrical opening of the electrical lock.

11. The vehicle according to claim 9, wherein the sliding door includes at least one opening control and sensors, wherein the electrical lock is opened by signals from the sensors that are triggered by actuating the at least one opening control.

12. The vehicle according to claim 11, wherein the sliding door includes:
a hook to retain the sliding door in an open position, and
a finger to cooperate with the electrical lock and to retain the sliding door in a closed position,
wherein the least one opening control includes a mechanical connection to the hook to mechanically actuate the hook.

13. The vehicle according to claim 5, further including an emergency opening control.

14. The vehicle according to 13, wherein the sliding door includes:
a hook to retain the sliding door in an open position,
a finger to cooperate with the electrical lock and to retain the sliding door in a closed position,
at least one opening control including a mechanical connection to the hook to mechanically actuate the hook, and
sensors to trigger an electrical opening of the electrical lock.

15. The vehicle according to claim 5, further including a lock pillar, wherein the lock is in the lock pillar.

16. The vehicle according to claim 15, wherein the sliding door includes:
a hook to retain the sliding door in an open position,
a finger to cooperate with the electrical lock and to retain the sliding door in a closed position,
at least one opening control including a mechanical connection to the hook to mechanically actuate the hook, and
sensors to trigger an electrical opening of the electrical lock.
